(19) United States
(12) Patent Application Publication
(10) Pub. No.: US 2012/0233240 A1
(43) Pub. Date: Sep. 13, 2012

(54) SCTP ASSOCIATION ENDPOINT RELOCATION IN A LOAD BALANCING SYSTEM

(75) Inventors: Abdallah CHATILLA, Montreal (CA); Richard TREMBLAY, Rosemere (CA)

(73) Assignee: TELEFONAKTIEBOLAGET L M ERICSSON (PUBL), Stockholm (SE)

(21) Appl. No.: 13/044,210

(22) Filed: Mar. 9, 2011

(51) Int. Cl. G06F 15/16

(52) U.S. Cl. 709/203

(57) ABSTRACT

Presented is a system and methods for relocating a Stream Control Transmission Protocol (SCTP) association from a first back-end server to a second back-end server without disturbing the SCTP association connection. The front-end server coordinates the replacement by requesting SCTP association connection parameters from the first back-end server and providing the SCTP association connection parameters to the second back-end server. Further, the front-end server discards any SCTP association packets, not necessary to the replacement, directed to the two back-end servers during the replacement. Throughout the replacement, the client, on the non-relocating end of the SCTP association, is unaware of the replacement or the existence of the front-end server.

### TECHNICAL FIELD

The present invention relates generally to load balancing a series of servers and more specifically to load balancing a series of servers based on replacing an SCTP Association endpoint of one server with an SCTP Association endpoint on another server.

### BACKGROUND

As the popularity of the internet and the functionality of websites continue to grow, many websites require multiple servers to handle the load of communications traffic directed toward their pages. In another use of the internet, Voice over Internet Protocol service has grown to a volume where many servers are required to handle the demand for a given service provider. As the requirement for multi-server systems evolves, a need arises for the ability to balance the load generated for the service across the number of deployed servers providing the service.

Further, the desire to handle the signaling of telecommunications over Internet Protocol (IP) and the growth in complexity of websites with regard to providing a rich multimedia experience combined with reliable and responsive communications has led to the development of communication protocols such as Stream Control Transmission Protocol (SCTP). SCTP provides a connection-oriented protocol, similar to Transmission Control Protocol (TCP), on top of the connectionless IP and includes the additional features of multi-homing and multi-streaming that are not available with TCP. These additional features allow a more efficient communication between a multitude of clients and servers.

A load-balancing system for multiple servers is desired that provides the features of SCTP but with one or more of: 1) replace an SCTP application endpoint on one server with an SCTP application endpoint on a different server while maintaining the SCTP association i.e. the client should be unaware of the transition to a new server 2) no modifications to the SCTP protocol; 3) minimize the amount of SCTP chunk inspection; 4) minimize association state storing; 5) minimize SCTP checksum recalculation; 6) no modifications to the IP header; 7) support the SCTP multi-homing feature; 8) transparent to users of the socket Application Programming Interface (API); and 9) no modifications to the server IP communications stack. A number of attempts, based on a Network Address Translation (NAT) scheme, to provide a solution have been attempted but these solutions typically do not meet some or all of the characteristics specified above.

Consequently, market pressure is building for a load-balancing capable system which would meet the characteristics specified above and would also allow, among other things, the ability to scale the system capacity as required without interference with the currently operating servers or the applications and associations running on the operating servers.

### SUMMARY

Systems and methods address the market needs described above by providing an intermediate front-end server to route SCTP communications between clients requesting a service and back-end servers providing the service. The front-end server and a series of back-end servers share a Virtual Internet Protocol (VIP) address and SCTP port numbers allowing the clients to access the service without knowledge of the specific back-end server providing the service. In fact, according to an embodiment the back-end servers operate independently and are not aware that other back-end servers exist or that a front-end server is acting as an intermediary. In a similar fashion, the client is unaware of the presence of the front-end server and believes the SCTP communication interaction is directly with the back-end server.

In one exemplary embodiment, a method is illustrated for replacing an SCTP Association endpoint on a first back-end server with an SCTP Association endpoint on a second back-end server without disconnecting the SCTP Association. In a first exemplary embodiment step, a first notification is received at a front-end server that a first SCTP Association endpoint on a first back-end server is being replaced with a second SCTP Association endpoint on a second back-end server. In the next exemplary embodiment step, the front-end server begins discarding any received SCTP Association packets directed toward the first SCTP Association endpoint on the first back-end server. In another exemplary embodiment step, the front-end server sends a second notification to the second back-end server to replace the first SCTP Association endpoint on the first back-end server. In the next exemplary embodiment step, the front end server begins routing SCTP Association packets toward a second SCTP Association endpoint on the second back-end server.

In another exemplary embodiment, a method is illustrated for replacing an SCTP Association endpoint by a back-end server. In a first exemplary embodiment step, the back-end server receives a notification to replace the SCTP Association endpoint. In another exemplary embodiment step, the back-end server connects to a client associated with the SCTP Association endpoint. In the next exemplary embodiment step, the back-end server sends an SCTP Association initialization packet toward the client.

In another exemplary embodiment, a server for facilitating the replacement of a first SCTP Association endpoint on a first back-end server with a second SCTP Association endpoint on a second back-end server is presented. The exemplary server embodiment includes a replacement component for processing SCTP Association packets associated with SCTP Association endpoint replacement. The exemplary server embodiment further includes a replacement management component for coordinating communications between the server, the SCTP Association endpoint on the first back-end server and the SCTP Association endpoint on the second back-end server.

### BRIEF DESCRIPTION OF THE DRAWINGS

The accompanying drawings illustrate exemplary embodiments, wherein:

FIG. 1 depicts a system for a front-end node to replace an SCTP association endpoint at a first back-end serving node with an SCTP association endpoint at a second back-end serving node without disconnecting the SCTP Association or disturbing the SCTP Association endpoint at a client;

FIG. 2 depicts a system for a front-end node to replace an SCTP association endpoint at a first back-end serving node with an SCTP association endpoint at a second back-end serving node without disconnecting the SCTP Association or disturbing the SCTP Association endpoint at a client wherein the front-end node is facilitated by an initialization component, an engine component and a storage component;

FIG. 3 depicts a system for a front-end node to replace an SCTP association endpoint at a first back-end serving node with an SCTP association endpoint at a second back-end serving node without disconnecting the SCTP Association or disturbing the SCTP Association endpoint at a client wherein the initialization component is facilitated by a client initializing component and a back-end server initializing component;

FIG. 4 depicts a system for a front-end node to replace an SCTP association endpoint at a first back-end serving node with an SCTP association endpoint at a second back-end serving node without disconnecting the SCTP Association or disturbing the SCTP Association endpoint at a client wherein the engine component is facilitated by a replacement component and the replacement component is facilitated by a replacement management component;

FIG. 5 is a signaling diagram depicting an SCTP association requests and responses between a client and a back-end server through a load-balancing front-end server with the client initiating the communication;

FIG. 6 is a signaling diagram depicting an SCTP association requests and responses between a client and a back-end server through a load-balancing front-end server with the back-end server initiating the communication;

FIG. 7 is a signaling diagram depicting SCTP association post-initialization communications from a client to a back-end server through a load-balancing front-end server;

FIG. 8 is a flowchart depicting a method for replacing an SCTP Association endpoint at a first back-end server with an SCTP Association endpoint at a second back-end server without disconnecting said SCTP Association or disturbing the SCTP Association endpoint connected to a client; and

FIG. 9 depicts an exemplary computing device for implementing a system for a load-balancing front-end node to establish and route an SCTP connection between a client and a back-end serving node based on a back-end serving node generated SCTP verification tag.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

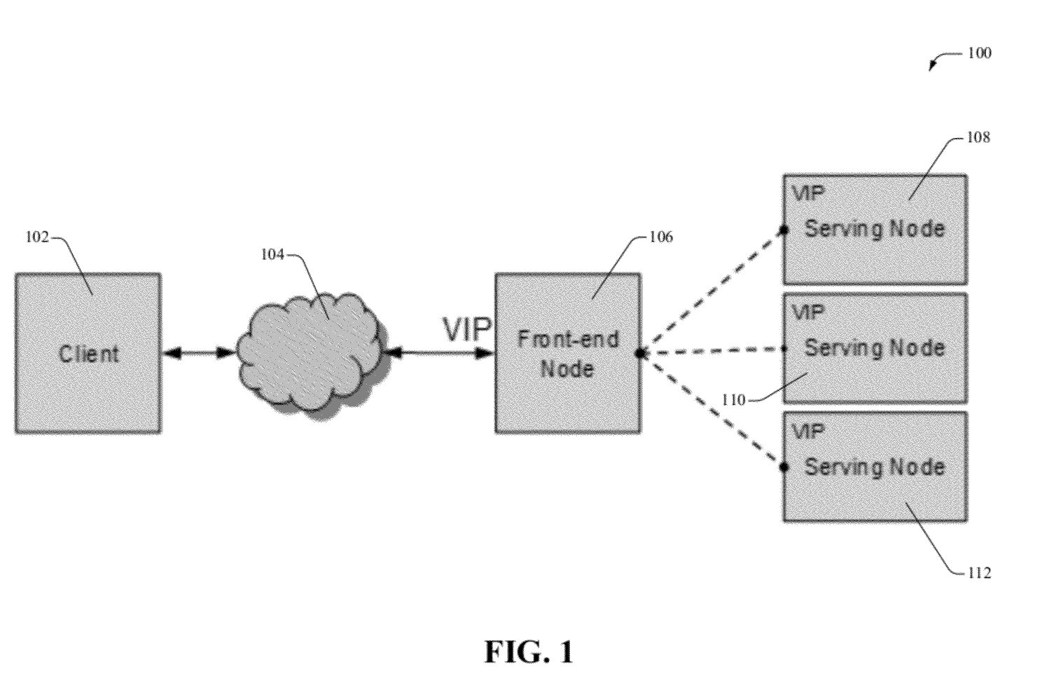

Looking first to FIG. 1, a diagram of an exemplary embodiment of a load-balancing SCTP association system 100 for providing communication distribution based on verification tag mediation is illustrated. The exemplary embodiment of the load-balancing SCTP association system 100 includes but is not limited to an exemplary client 102, an exemplary network 104, an exemplary front-end node 106 (i.e. front-end server) and three exemplary back-end nodes 108, 110, 112 (i.e. back-end servers). It should be noted in this exemplary embodiment that the terms node and server can be used interchangeably. It should also be noted in this exemplary embodiment that the back-end servers 108, 110, 112 can be any number of back-end servers 108, 110, 112 operating independently.

In one aspect of the exemplary embodiment, the client 102 is any device capable of requesting a service from a front-end server 106 communicatively connected to the client 102 across a network 104. In one example of the exemplary embodiment the client 102 includes but is not limited to a personal computer running a web browser and accessing a web page located at a website on the internet. In another aspect of the exemplary embodiment, the client 102 is configured to communicate to the front-end server 106 with the Stream Control Transport Protocol (SCTP) for connection-oriented support. Further in the exemplary embodiment, the client 102 is a telephone connected to a Voice over Internet Protocol (VoIP) device to communicate across a network 104 such as the internet to a front-end server for voice communications.

In another aspect of the exemplary embodiment, the network 104 provides a communications link between the client 102 and the front-end server 106. In one configuration of the exemplary embodiment, the network 104 can be the internet. Continuing with the exemplary embodiment, a front-end server 106 provides the capability to transparently route communications between a client 102 and one of a series of back-end servers 108, 110, 112 by using the SCTP verification tag as a distribution key. In a further aspect of the exemplary embodiment, the series of back-end servers 108, 110, 112 provide the application services desired by the client 102. It should be noted that although a single client 102 is illustrated, a plurality of clients 102 can be connected to the series of back-end servers 108, 110, 112. In a further aspect of the exemplary embodiment, the back-end servers 108, 110, 112 are unaware of each other and operate independently with their connected clients 102. It should also be noted that the back-end servers 108, 110, 112 and the client(s) 102 are unaware of the front-end server 106, the front-end server is transparent to the connection between the client(s) 102 and the back-end servers 108, 110, 112 and routes communications between the client(s) 102 and the back-end servers 108, 110, 112 based on the SCTP verification tags created by the back-end servers 108, 110, 112 for the SCTP association.

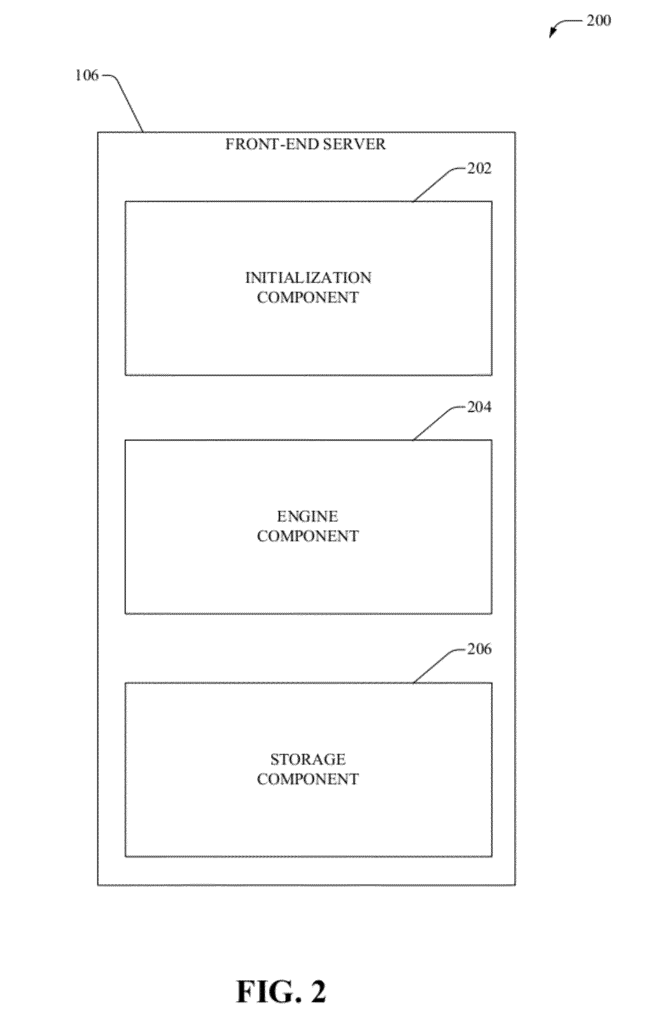

Looking now to FIG. 2, another exemplary embodiment 200 is depicted as a portion of exemplary embodiment 100. Exemplary embodiment 200 depicts a front-end server 106 including an initialization component 202, an engine component 204 and a storage component 206. In one aspect of the exemplary embodiment 200 the initialization component 202 can provide the capability to facilitate the creation of a non-clashing SCTP connection from either a client 102 or a back-end server 108.

In another aspect of the exemplary embodiment 200, the initialization component 202 can generate a distribution key based on a combination of the client 102 provided SCTP port number, the back-end server 108 provided SCTP port number and the back-end server 108 provided SCTP Initiate-Tag. Continuing with the exemplary embodiment, the front-end server 106 uses the distribution key to route communications between a client 102 and a back-end server 108 and guaranty that all communications received at the front-end server 106 are delivered to the appropriate end-point.

In another aspect of the exemplary embodiment 200, the initialization component 202 creates and maintains a verification tag translation table to prevent any clash between distribution keys. In this exemplary embodiment, a clash would develop if two client 102/back-end server 108 pairs provided port numbers and an Initiate-Tag that combined to form identical distribution tags. Continuing with the exemplary embodiment, as the front-end server 106 is initiating an SCTP association between a client 102 and a back-end server 108 the front-end server creates the distribution key based on the client 102/back-end server 108 port numbers and the Initiate-Tag provided by the back-end server 108. Next in the exemplary embodiment, the front-end server 106 looks in the verification tag translation table for an identical distribution key and if none is found then the SCTP association as initialized can continue with the front-end server 106 correctly routing communications between the client 102 and the back-end server 108 based on the distribution key.

Further in the exemplary embodiment, if the front-end server 106 finds a match of the distribution key in the verification tag translation table then the front-end server 106 generates a new Initiate-Tag value and creates a new non-conflicting distribution key. Next in the exemplary embodiment, the front-end server 106 creates a new entry in the verification tag translation table to hold the distribution key pair and the association initialization continues with the front-end server 106 correctly routing communications between the client 102 and the back-end server 108 based on the distribution key pair maintained in the verification tag translation table by the front-end server 106.

In another aspect of the exemplary embodiment, the engine component 204 provides the ability to distribute communications between a client 102 and a back-end server 108 after completion of the SCTP association initialization. In one aspect of the exemplary environment, the front-end server 106 receives a SCTP communication from a client 102 directed to one of the back-end servers 108, 110, 112 sharing a virtual internet protocol (VIP) address with the front-end server 106. Continuing with the exemplary embodiment, the engine component 204 of the front-end server 106 attempts to find the distribution key of the SCTP communication in the verification tag translation table and if the distribution key is not found in the verification tag translation table then the engine component 204 of the front-end server 106 forwards the SCTP communication to the back-end server 108 specified by the distribution key. Further in the exemplary embodiment, if the distribution key is found in the verification tag translation table then the engine component 204 of the front-end server 106 substitutes the distribution key in the communication with the associated distribution key in the verification tag translation table and recalculates the checksum, if required, for the communication and forwards the communication to the back-end server 108 specified by the replacement distribution key.

Continuing with another aspect of the exemplary embodiment, a storage component 206 provides the ability to store data associated with maintaining SCTP associations between a client 102 and a back-end server 108. Further in the exemplary environment, the storage component 206 comprises a verification tag translation table and a count of the number of entries in the verification tag translation table. The verification tag translation table counter in the exemplary environment storage component 206 can be used to determine if there is any need to inspect the verification tag translation table, as long as the count is zero, there have not been any clashes in distribution key generation and the communications from any clients 102 to any back-end servers 108 can be forwarded without a search of the verification tag translation table.

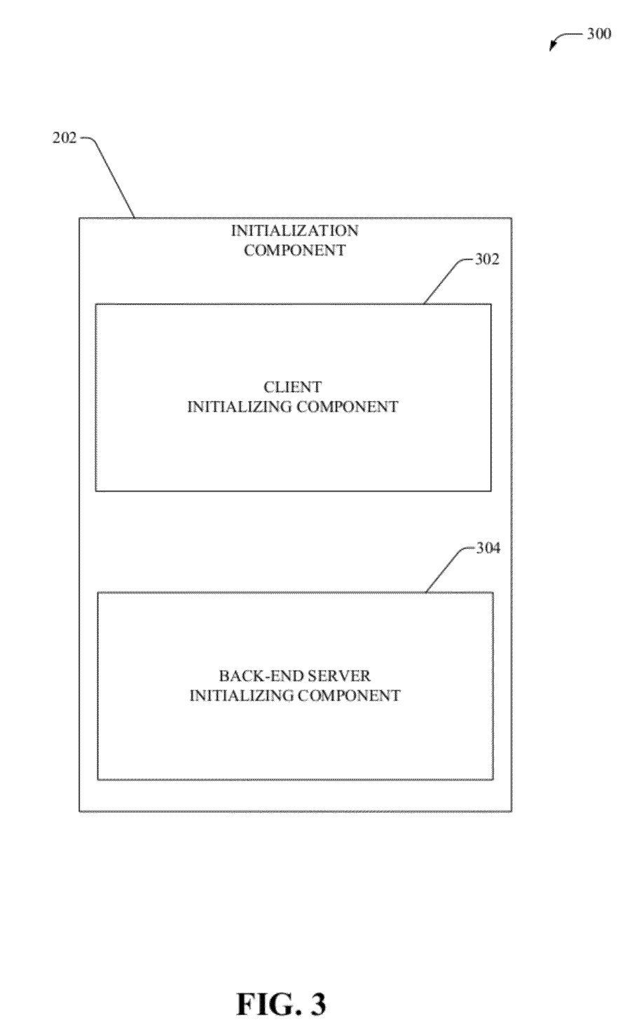

Turning now to FIG. 3, another exemplary embodiment 300 is depicted. A portion of the exemplary embodiment 300 depicts a client initialization component 302 and a back-end server initialization component 304. In one aspect of the exemplary embodiment 300, the client initialization component 302 provides the capability to manage an SCTP association initiated by a client 102. In the exemplary embodiment, the client initializing component 302 determines if the Initiate-Tag provided by the back-end server 108 would create a clashing distribution key with another SCTP association. Continuing with the exemplary embodiment, if a clashing distribution key is detected then the client initializing component 302 would replace the Initiate-Tag generated by the back-end server 108 with a non-clashing Initiate-Tag generated by the client initializing component 302, place the non-clashing Initiate-Tag in the INIT-ACK chunk and recalculate and replace the checksum in the SCTP common header.

Continuing with the exemplary embodiment, the back-end server initializing component 304 provides the capability to manage an SCTP association initiated by a back-end server 108. In the exemplary embodiment, the back-end server initializing component 304 determines if the Initiate-Tag provided by the back-end server 108 would create a clashing distribution key with another SCTP association. Continuing with the exemplary embodiment, if a clashing distribution key is detected then the back-end server initializing component 304 would replace the Initiate-Tag generated by the back-end server 108 with a non-clashing Initiate-Tag generated by the back-end server initializing component 304, place the non-clashing Initiate-Tag in the INIT chunk and recalculate and replace the checksum in the SCTP common header.

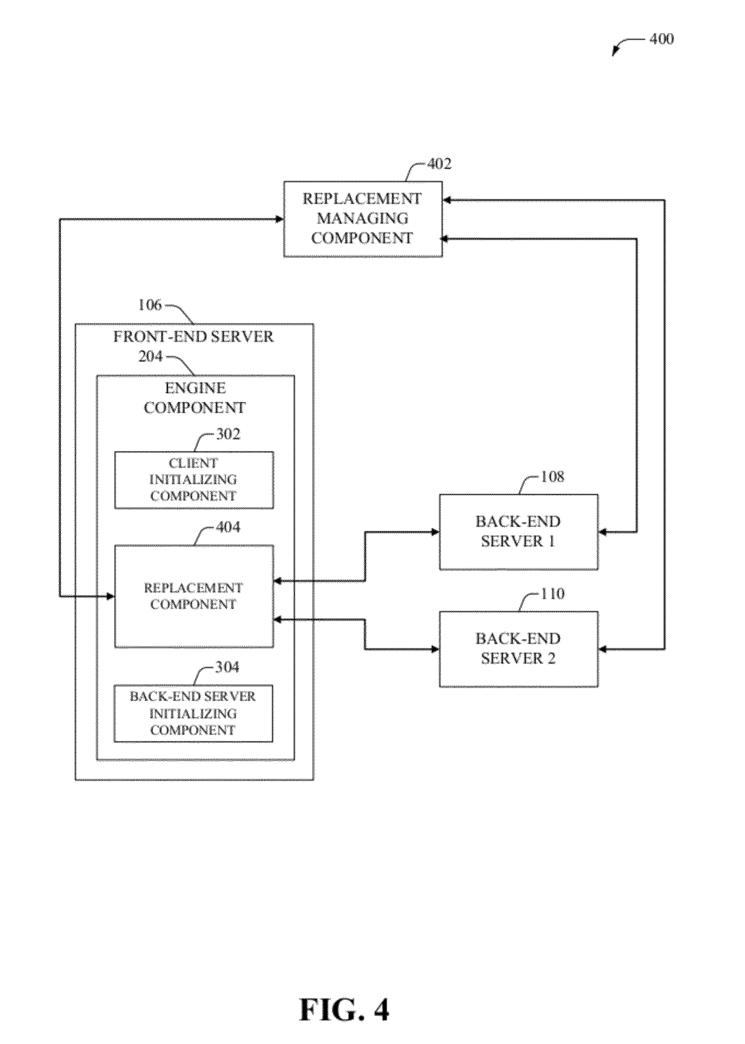

Turning now to FIG. 4, another exemplary embodiment 400 is depicted. A portion of the exemplary embodiment 400 depicts a replacement managing component 402, a replacement component 404 associated with a front-end server 106, a back-end server 108 and a back-end server 110. It should be noted in this exemplary embodiment that although the replacement management component 402 is depicted as a separate component, the replacement management component 402 can also be a part of the front-end server 106 or the engine component 204. It should also be noted in this exemplary embodiment that although the SCTP Association is relocating from back-end server 108 to back-end server 110, an SCTP Association can relocate from any back-end server associated with a front-end server to any other back-end server associated with said front-end server.

Continuing with the exemplary embodiment, the replacement management component 402 provides the capability to coordinate the replacement of an SCTP Association endpoint of a first back-end server 108 by a second back-end server 110. In one aspect of the exemplary embodiment, the replacement management component 402 receives notification that the SCTP Association is moving from back-end server 108 to back-end server 110. Further in the exemplary embodiment, the replacement management component 402 sends a request to the back-end server 108 for the SCTP Association parameters i.e. the port number of the client 102, the IP address of the client 102 and the port number of the back-end server 108.

In another aspect of the exemplary embodiment, the replacement management component 402 provides the capability to inform the replacement component 404 of the front-end server 106 that the SCTP Association is relocating from back-end server 108 to back-end server 110. Continuing with the exemplary embodiment, the replacement management component 402 provides the capability to inform the back-end server 110 that a SCTP Association is relocating to the back-end server 110 and provide the back-end server 110 with the SCTP Association replacement parameters obtained from back-end server 108.

In another aspect of the exemplary embodiment, the replacement component 404 of the front-end server 106 can provide the capability to discontinue delivery of SCTP Association packets to the back-end server 108 after receiving notification from the replacement management component 402 that the SCTP Association is relocating from back-end server 108 to back-end server 110. Continuing with the exemplary embodiment, the back-end server 110, after receiving notification from the replacement management component 402, can provide the capability to bind to the SCTP association port number, provided in the SCTP Association replacement parameters, on the back-end server 110 and connect to the client 102 IP address and client 102 port number provided in the SCTP Association replacement parameters.

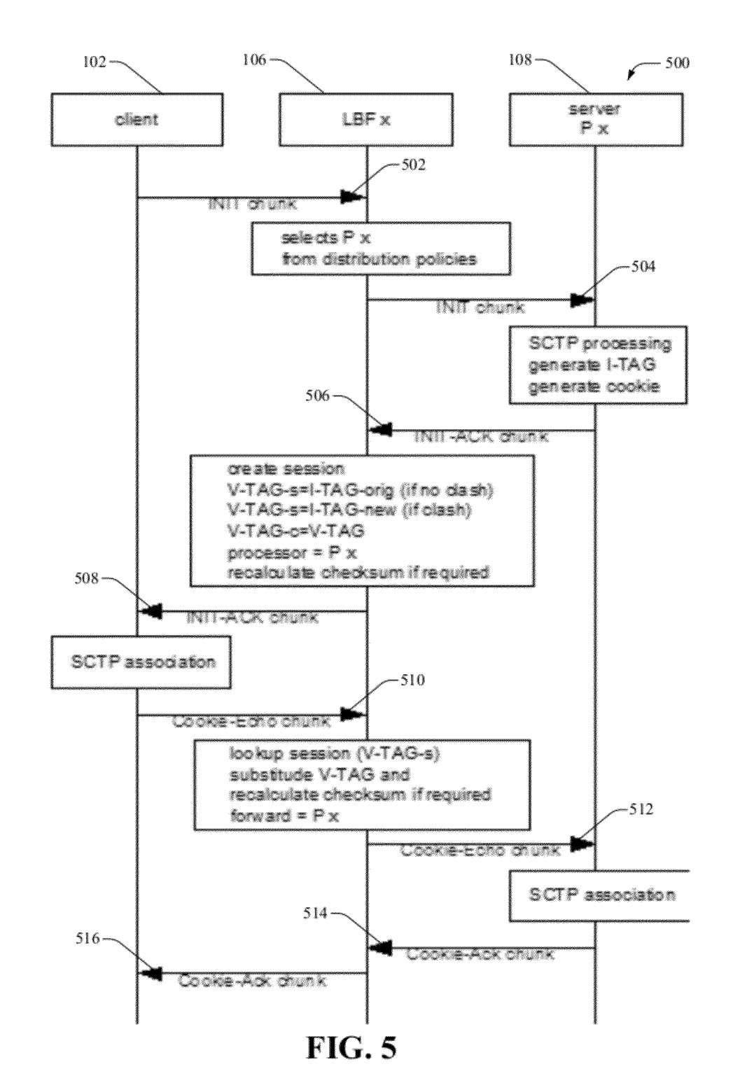

Turning now to FIG. 5, illustrated is an exemplary embodiment 500. The exemplary embodiment 500 depicts the signaling flow for a client 102 initiating an SCTP association with a back-end server 108 through a front-end server 106. It should be noted in the exemplary embodiment that the front-end server 106 and one or more back-end servers 108, 110, 112 share a virtual internet protocol (IP) address and the back-end servers 108, 110, 112 operate independently of each other. It should be further noted in the exemplary embodiment that the operation of the front-end server 106 is transparent to both the client 102 and the back-end server 108 involved in the SCTP association.

First, at exemplary embodiment step 502, the client 102 sends an SCTP INIT chunk towards the virtual IP address shared by the front-end server 106 and the series of back-end servers 108. In the exemplary embodiment, the front-end server 106 receives the SCTP INIT chunk and makes a determination based on distribution policies which back-end server 108 will receive the SCTP INIT chunk. Continuing at step 504 with the exemplary embodiment, the front-end server 106 forwards the SCTP INIT chunk to the selected back-end server 108. Continuing with the exemplary embodiment, the back-end server 108 processes the SCTP INIT chunk by generating an SCTP INIT-ACK chunk including an Initiate-Tag and the SCTP port number used by the back-end server 108 and at 506, sends the INIT-ACK chunk towards the client 102.

In the exemplary embodiment, the front-end server 106 receives the SCTP INIT-ACK chunk and inspects the contents of the INIT-ACK chunk to create a distribution key to manage the communications between the initiating client 102 and the selected back-end server 108. The exemplary embodiment continues with the front-end server 106 combining the client 102 SCTP port number with the Initiate-Tag and the back-end server 108 SCTP port number to create a distribution key for the SCTP association. Continuing with the exemplary embodiment, the front-end server 106 checks the verification tag translation table to confirm that the newly created distribution key is not already in use by another SCTP association managed by the front-end server 106. In the exemplary embodiment, if the distribution key is found in the verification tag translation table then the front-end server 106 generates a new Initiate-Tag and creates a non-clashing distribution key.

Next in the exemplary embodiment, the front-end server creates a new entry in the verification tag translation table for the client 102 and back-end server 108 generated Initiate-Tags and stores the values in the verification tag translation table. Continuing with the exemplary embodiment, the front-end server 106 updates the SCTP INIT-ACK chunk with the new Initiate-Tag and a recalculated checksum and, at step 508, forwards the updated SCTP INIT-ACK chunk to the client 102. It should be noted in the exemplary embodiment that if the front-end server 106 does not detect a clash of distribution keys then the front-end server 106 does not create an entry in the verification tag translation table for the SCTP association.

Continuing at step 510 of the exemplary environment, the client 102 sends a COOKIE-ECHO chunk towards the back-end server 108 and the intermediate front-end server 106 inspects the COOKIE-ECHO chunk to determine if the distribution key is a match with any of the distribution keys stored in the verification tag translation table. In the exemplary embodiment, if the distribution key matches an entry of the verification tag translation table then the front-end server 106 replaces the Verification-Tag in the COOKIE-ECHO chunk with the Initiate tag from the verification tag translation table, replaces the checksum with a checksum recalculated based on the replaced Verification-Tag and, at step 512, forwards the COOKIE-ECHO chunk to the back-end server 108. Next in the exemplary embodiment at 514, the back-end server 108 sends a COOKIE-ACK chunk towards the client 102 and at step 516 the front-end server 106 transparently forwards the COOKIE-ACK chunk towards the client 102.

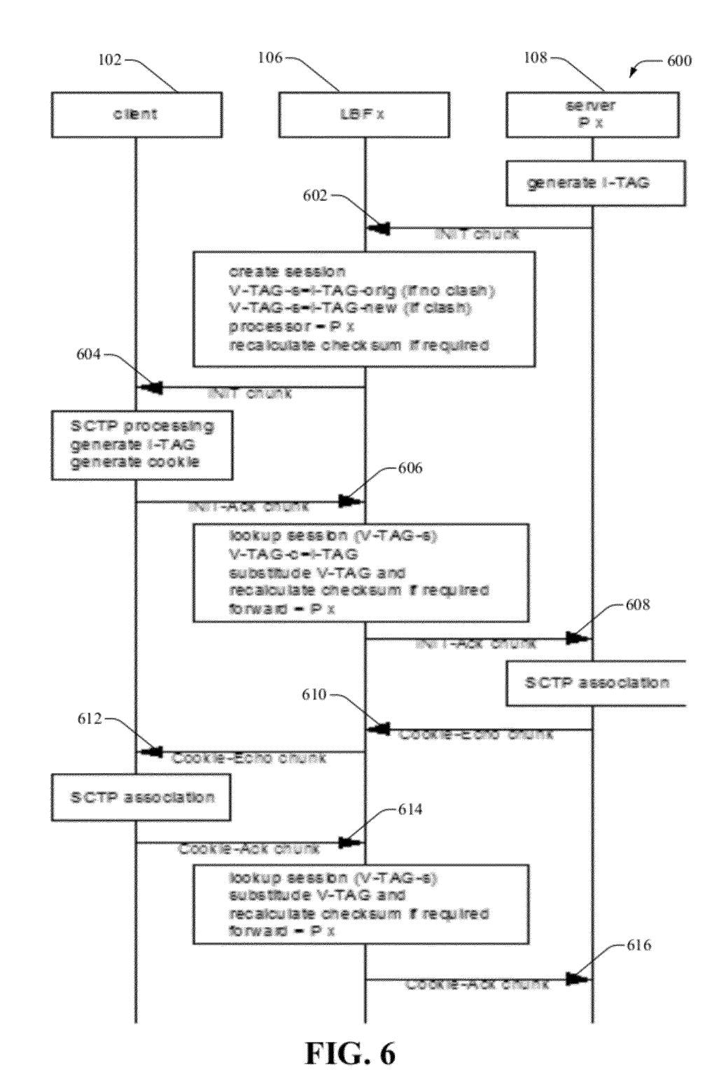

Turning now to FIG. 6, illustrated is an exemplary embodiment 600. The exemplary embodiment 600 depicts the signaling flow for a back-end server 108 initiating an SCTP association with a client 102 through a front-end server 106. It should be noted in the exemplary embodiment that the front-end server 106 and one or more back-end servers 108 share a virtual internet protocol (IP) address and the back-end servers 108, 110, 112 operate independently of each other. It should be further noted in the exemplary embodiment that the operation of the front-end server 106 is transparent to both the client 102 and the back-end server 108 involved in the SCTP association.

First, in the exemplary embodiment, the back-end server 108 generates an Initiate-Tag and sends the Initiate-Tag, at step 602, in an SCTP INIT chunk towards the client 102 transparently through the front-end server 106. Next in the exemplary embodiment, the front-end server 106 receives the SCTP INIT chunk from the back-end server 108 and transparently inspects the contents of the INIT chunk to create a distribution key to manage the communications between the destination client 102 and the initiating back-end server 108. The exemplary embodiment continues with the front-end server 106 combining the client SCTP port number with the back-end server 108 generated Initiate-Tag and the back-end server 108 SCTP port number to create a distribution key for the SCTP association.

Continuing with the exemplary embodiment, the front-end server 106 checks the verification tag translation table to confirm that the newly created distribution key is not already in use by another SCTP association managed by the front-end server 106. In the exemplary embodiment, if the distribution key is found in the verification tag translation table then the front-end server 106 generates a new Initiate-Tag to replace the back-end server 108 generated Initiate-Tag and creates a non-clashing distribution key. Next in the exemplary embodiment, the front-end server creates a new entry in the verification tag translation table for the client 102 and back-end server 108 generated Initiate-Tag and SCTP port numbers and stores the values in the verification tag translation table.

Continuing at step 604 with the exemplary embodiment, the front-end server 106 forwards the SCTP INIT chunk to the client 102 and the client 102 processes the SCTP INIT chunk by generating an SCTP INIT-ACK chunk including a client generated Initiate-Tag and a cookie associated with the client and, at step 606, sends the INIT-ACK chunk towards the back-end server 108 through the front-end server 106.

Next in the exemplary embodiment, the front-end server 106 receives the SCTP INIT-ACK chunk from the client 102 and transparently inspects the contents of the SCTP packet common header to retrieve the distribution key used to distribute the SCTP INIT-ACK to the appropriate back-end server 108. Continuing with the exemplary embodiment, the front-end server 106 checks the verification tag translation table to determine if the distribution key is in the verification tag translation table. In the exemplary embodiment, if the distribution key is found in the verification tag translation table then the front-end server 106 replaces the Verification-Tag in the SCTP common header of the INIT-ACK message with the associated back-end server 108 Initiate-Tag from the verification tag translation table and updates the checksum before forwarding the SCTP INIT-ACK to the appropriate back-end server 108 at step 608. It should be noted in the exemplary embodiment that if the front-end server 106 does not detect a clash of distribution keys then the front-end server 106 simply forwards the SCTP INIT-ACK to the appropriate back-end server 108 based on the Verification-Tag retrieved from the SCTP common header and the back-end server establishes an SCTP association with the client.

Continuing at step 610 of the exemplary environment, the back-end server 108 sends a COOKIE-ECHO chunk towards the client 102 through the front-end server 106 and the front-end server 106 transparently forwards, at step 612, the COOKIE-ECHO to the client 102 and the client establishes an SCTP association with the back-end server 108. Next in the exemplary embodiment at 614, the client 102 sends a COOKIE-ACK chunk towards the back-end server 108 and at step 616 the front-end server 106 determines if a distribution key exists for this SCTP association and accordingly if an exchange of Verification-Tags is required. The exemplary embodiment continues with the front-end server 106 transparently, with regard to the client 102 and the back-end server 108, forwarding the COOKIE-ACK chunk towards the back-end server 108.

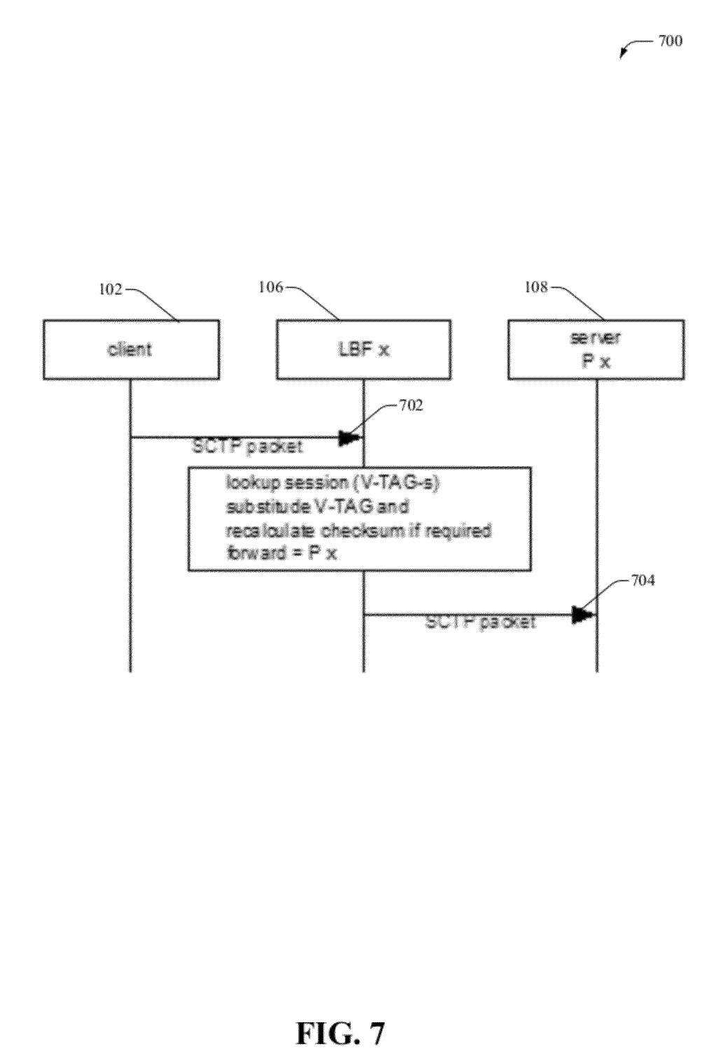

Turning now to FIG. 7, illustrated is an exemplary embodiment 700. The exemplary embodiment 700 depicts the signaling flow for a client 102 communicating through a front-end server 106 to a back-end server 108 using an established SCTP association. It should be noted in the exemplary embodiment that the front-end server 106 and one or more back-end servers 108, 110, 112 share a virtual internet protocol (IP) address and the back-end servers 108 operate independently of each other. It should be further noted in the exemplary embodiment that the operation of the front-end server 106 is transparent to both the client 102 and the back-end server 108 involved in the SCTP association.

Next in the exemplary embodiment, a client 102 sends, at step 702, an SCTP packet through the front-end server 106 towards a back-end server 108. The front-end server 106 receives the SCTP packet from the client 102 and transparently inspects the contents of the SCTP packet to retrieve the distribution key used to distribute the SCTP packet to the appropriate back-end server 108. Continuing with the exemplary embodiment, the front-end server 106 checks the verification tag translation table to determine if the distribution key is in the verification tag translation table. In the exemplary embodiment, if the distribution key is found in the verification tag translation table then the front-end server 106 replaces the Verification-Tag in the SCTP packet common header with the associated back-end server 108 Initiate-Tag from the verification tag translation table and updates the checksum before forwarding the SCTP packet to the appropriate back-end server 108 at step 704. It should be noted in the exemplary embodiment that if the front-end server 106 does not detect a clash of distribution keys then the front-end server 106 forwards the SCTP packet to the appropriate back-end server 108 based on the Verification-Tag retrieved from the SCTP packet common header.

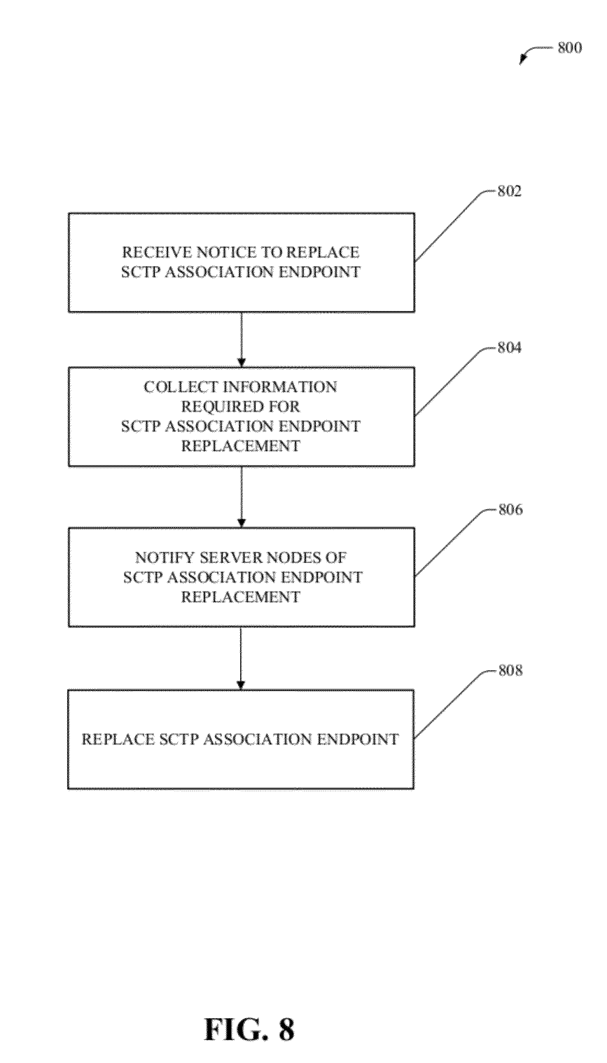

Continuing at FIG. 8, an exemplary method embodiment 800 for relocating an SCTP association is depicted. Starting at step 802, the exemplary method embodiment 800 can receive a request to relocate an SCTP association from a first back-end server 108 to a second back-end server 110. In the exemplary embodiment the replacement request can come from an operator manually invoking the replacement request or it can come from a load balancing system automatically determining when to direct replacement. Continuing with the exemplary embodiment at step 804, the replacement managing component 402 will request the SCTP Association parameters from the back-end server 108 hosting the SCTP Association. In the exemplary embodiment, the SCTP Association parameters include but are not limited to the source and destination port numbers and the destination IP address.

Next, at step 806 of the exemplary embodiment, the method 800, through the replacement managing component 402, notifies the replacement component 404, of the front-end server 106, and the back-end server 110, receiving the SCTP Association, of the SCTP Association replacement. In one aspect of the exemplary embodiment, after receiving notification, the replacement component 404 of the front-end server 106 discontinues routing any further SCTP packets toward the back-end server 108 hosting the SCTP association. In another aspect of the exemplary embodiment, after receiving notification, the back-end server 110 receiving the SCTP Association binds to the source port number received in the notification and connects to the destination IP address and port number received in the notification.

Continuing at step 808 of the exemplary embodiment, the SCTP Association relocates to the back-end server 110. In one aspect of the exemplary embodiment, the SCTP stack on the back-end server 110 generates an INIT chunk with a new Initiate-Tag and a new Initial-Transmission Sequence Number (I-TSN) and sends the INIT chunk towards the client 102. Continuing with the exemplary embodiment, the SCTP stack on the client 102 detects the INIT chunk in the middle of an established SCTP Association and sends an INIT-ACK with a new Initiate-Tag and a copy of the Tie-Tags, configured to a reserved location within the Cookie as described by section 5.2.2 of the SCTP Request for Comments (RFC) 4960 dated September 2007, incorporated herein by reference. Continuing with the exemplary embodiment, the front-end server 106 forwards the INIT-ACK chunk towards the back-end server 110 receiving the relocated SCTP Association and, at this point, does not route any data packets toward the back-end server 110. In another aspect of the exemplary embodiment, the SCTP stack on the back-end server 110 generates a COOKIE-ECHO chunk including the cookie received with the INIT-ACK chunk just received. Continuing with the exemplary embodiment, the back-end server 110 sends the COOKIE-ECHO chunk towards the client 102 and when the client 102 receives the COOKIE-ECHO chunk with the copy of the Tie-Tags, the client 102 sends a COOKIE-ACK chunk towards the back-end server 110 by way of the front-end server 106. In the exemplary embodiment, when the replacement component 404 of the front-end server 106 receives the COOKIE-ACK chunk, the replacement component 404 forwards the COOKIE-ACK chunk, as well as any subsequent chunks to the back-end server 110 therefore relocating the SCTP Association from back-end server 108 to back-end server 110.

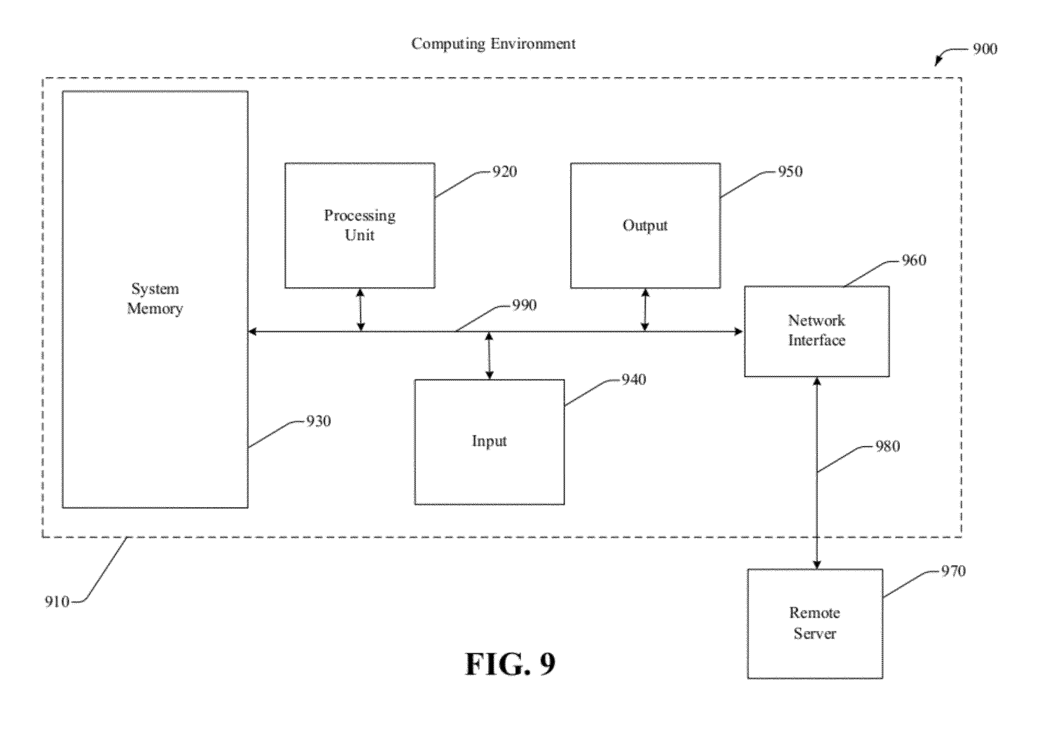

FIG. 9 illustrates an example of a suitable computing system environment 900 in which the claimed subject matter can be implemented, although as made clear above, the computing system environment 900 is only one example of a suitable computing environment for an exemplary embodiment and is not intended to suggest any limitation as to the scope of use or functionality of the claimed subject matter. Further, the computing environment 900 is not intended to suggest any dependency or requirement relating to the claimed subject matter and any one or combination of components illustrated in the example computing environment 900.

Looking now to FIG. 9, an example of a device for implementing the previously described innovation includes a general purpose computing device in the form of a computer 910. Components of computer 910 can include, but are not limited to, a processing unit 920, a system memory 930, and a system bus 990 that couples various system components including the system memory 930 to the processing unit 920. The system bus 990 can be any of several types of bus structures including a memory bus or memory controller, a peripheral bus, and a local bus using any of a variety of bus architectures.

Computer 910 can include a variety of computer readable media. Computer readable media can be any available media that can be accessed by computer 910. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media can embody computer readable instructions, data structures, program modules or other data in a modulated data signal such as a carrier wave or other transport mechanism and can include any suitable information delivery media.

The system memory 930 can include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, can be stored in memory 930. Memory 930 can also contain data and/or program modules that are immediately accessible to and/or presently being operated on by processing unit 920. By way of non-limiting example, memory 930 can also include an operating system, application programs, other program modules, and program data.

The computer 910 can also include other removable/non-removable and volatile/nonvolatile computer storage media. For example, computer 910 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 990 through a non-removable memory interface such as an interface, and a magnetic disk drive or optical disk drive can be connected to the system bus 990 by a removable memory interface, such as an interface.

A user can enter commands and information into the computer 910 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 920 through user input 940 and associated interface(s) that are coupled to the system bus 990, but can be connected by other interface and bus structures, such as a parallel port, game port or a universal serial bus (USB).

A graphics subsystem can also be connected to the system bus 990. In addition, a monitor or other type of display device can be connected to the system bus 990 through an interface, such as output interface 950, which can in turn communicate with video memory. In addition to a monitor, computers can also include other peripheral output devices, such as speakers and/or printing devices, which can also be connected through output interface 950.

The computer 910 can operate in a networked or distributed environment using logical connections to one or more other remote computers, such as remote server 970, which can in turn have media capabilities different from device 910. The remote server 970 can be a personal computer, a server, a router, a network PC, a peer device or other common network node, and/or any other remote media consumption or transmission device, and can include any or all of the elements described above relative to the computer 910. The logical connections depicted in FIG. 9 include a network 980, such as a local area network (LAN) or a wide area network (WAN), but can also include other networks/buses.

When used in a LAN networking environment, the computer 910 is connected to the LAN 980 through a network interface or adapter. When used in a WAN networking environment, the computer 910 can include a communications component, such as a modem, or other means for establishing communications over a WAN, such as the Internet. A communications component, such as a modem, which can be internal or external, can be connected to the system bus 990 through the user input interface at input 940 and/or other appropriate mechanism.

In a networked environment, program modules depicted relative to the computer 910, or portions thereof, can be stored in a remote memory storage device. It should be noted that the network connections shown and described are exemplary and other means of establishing a communications link between the computers can be used.

Additionally, it should be noted that as used in this application, terms such as “component,” “display,” “interface,” and other similar terms are intended to refer to a computing device, either hardware, a combination of hardware and software, software, or software in execution as applied to a computing device implementing a virtual keyboard. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

Further, the term to “infer” or “inference” refer generally to the process of reasoning about or inferring states of the system, environment, user, and/or intent from a set of observations captured from events and/or data. Captured events and data can include user data, device data, environment data, behavior data, application data, implicit and explicit data, etc. Inference can be employed to identify a specific context or action, or can generate a probability distribution over states, for example. The inference can be probabilistic in that the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The above-described exemplary embodiments are intended to be illustrative in all respects, rather than restrictive, of the present innovation. Thus the present innovation is capable of many variations in detailed implementation that can be derived from the description contained herein by a person skilled in the art. All such variations and modifications are considered to be within the scope and spirit of the present innovation as defined by the following claims. No element, act, or instruction used in the description of the present application should be construed as critical or essential to the invention unless explicitly described as such. Also, as used herein, the article “a” is intended to include one or more items.

1. A method of routing Stream Control Transport Protocol (SCTP) packets, said method comprising:
receiving, by a front-end server, a first notification of a replacement of an SCTP association endpoint associated with said SCTP packets at a first SCTP Association endpoint by a second SCTP Association endpoint;
discarding, by said front-end server, said SCTP packets received by said front-end server directed toward said first SCTP association endpoint;
sending, by said front-end server, a second notification of said replacement toward said second SCTP Association endpoint; and
routing, by said front-end server, said SCTP packets toward said second SCTP Association endpoint which are received by said front-end server after said replacement.

2. The method of claim 1, wherein said notification further comprises parameters associated with said replacement.

3. The method of claim 2, wherein said parameters further comprise:
a first port number associated with a client;
an Internet Protocol (IP) address associated with said client; and
a second port number associated with said first SCTP association endpoint.

4. The method of claim 2, wherein said front-end server requests said parameters from said first SCTP Association endpoint.

5. The method of claim 1, wherein said front-end server, said first SCTP Association endpoint and said second SCTP Association endpoint share a Virtual Internet Protocol (VIP) address.

6. The method of claim 1, wherein said first notification is received from an operator.

7. The method of claim 1, wherein said first notification is received from a load balancing system.

8. The method of claim 1, wherein said first notification is received from a maintenance system.

9. A method of replacing a Stream Control Transport Protocol (SCTP) Association endpoint, said method comprising:
receiving, by a back-end server, a notification to replace said SCTP Association endpoint;
connecting, by said back-end server, to a client associated with said SCTP Association endpoint; and
sending, by said back-end server, an SCTP Association initialization packet toward said client.

10. The method of claim 9, wherein said notification further comprises parameters associated with said client.

11. The method of claim 10, wherein said parameters further comprise:
a first port number associated with said client;
an Internet Protocol (IP) address associated with said client; and
a second port number associated with said SCTP association endpoint.

12. The method of claim 9, wherein said back-end server uses the same Internet protocol (IP) address as said SCTP Association endpoint.

13. The method of claim 11, wherein said connecting further comprises binding, by said back-end server, to said second port number.

14. The method of claim 13, wherein said connecting further comprises connecting, by said back-end server, to said first port number at said IP address.

15. The method of claim 9, wherein said SCTP association initialization packet comprises an initiate tag and an initial transmission sequence number associated with said back-end server.

16. A server for facilitating Stream Control Transport Protocol (SCTP) association endpoint replacement of a first SCTP Association endpoint by a second SCTP Association endpoint, said server comprising:
a replacement component for processing SCTP packets associated with said SCTP association endpoint replacement; and
a replacement management component for coordinating communications between a first SCTP Association endpoint, a said second SCTP Association endpoint and said server during said SCTP Association endpoint replacement of said first SCTP Association endpoint with said second SCTP Association endpoint.

17. The server of claim 16, configured to share a Virtual Internet Protocol (VIP) address between said first SCTP Association endpoint, said second SCTP Association endpoint and said server.

18. The server of claim 16, wherein said replacement management component is configured to accept manual input from an operator for initiating said SCTP association endpoint replacement.

19. The server of claim 16, wherein said replacement management component is configured to accept an output from a load balancing system as input for initiating said SCTP Association endpoint replacement.

20. The server of claim 16, wherein said replacement component is configured to discard SCTP association data packets directed toward said second SCTP Association endpoint during said SCTP association endpoint replacement.

21. The server of claim 16, wherein said replacement component is configured to discard SCTP association packets directed toward said first SCTP Association endpoint during said SCTP Association endpoint replacement.

22. The server of claim 16, wherein said replacement management component is configured to allow management of said SCTP association endpoint replacement, from a separate node.

23. The server of claim 16, wherein said replacement management component further comprises coordinating SCTP association communications with a client associated with said SCTP association replacement.
